(19) United States
(12) Patent Application Publication
(10) Pub. No.: US 2006/0236332 A1
(43) Pub. Date: Oct. 19, 2006

(54) Television broadcast signal receiver

(75) Inventor: Takahiro Kurose, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/402,806

(22) Filed: Apr. 13, 2006

(30) Foreign Application Priority Data
Apr. 13, 2005 (JP) 2005-115402

(51) Int. Cl. H04H 9/00; H04N 5/50

(52) U.S. Cl. 725/13; 348/731

(57) ABSTRACT

A TV receiver 1 stores viewing record of each receivable channel with a tuner 11 in a memory 17. A main controller 18 extracts a plurality of channels having viewing frequency equal to or higher than a predetermined level based on the viewing record of each channel stored in the memory 17 and decides an order of viewing frequency of the extracted channels. When a simplified channel selection button 42 is operated by a user, the main controller 18 controls the channel selection based on the order of viewing frequency so that the channels are serially selected in the order of largeness of the viewing frequency at a time when the simplified channel selection button 42 is operated. Thereby, the channels having high viewing frequency can be selected with a simple operation without previous listing of favorite channels.

### BACKGROUND OF THE INVENTION

1. Field of the Invention

The present invention relates to a television broadcast signal receiver for receiving a television broadcast signal based on an operation of channel selection by a user.

2. Description of the Related Art

In late years, operation for selecting a channel by a user in a television broadcast signal receiver (hereinafter, it is abbreviated as TV receiver) becomes complex with incrementation of a number of channels due to multi channel of the TV broadcast. For example, in a conventional TV receiver, the user is required to input a number of a channel, which is desired to view, among the receivable channels more than one hundred with using numerical keypads, so that plural operation procedures was needed. Generally, it is rare that the user views such many channels thoroughly, and the channels which are frequently viewed by the user are exclusive. Thus, it is expected to select only the channels frequently viewed easily.

Japanese Laid-Open Patent Publication No. 3-214919 or 4-207718 discloses a conventional TV receiver which selects a channel frequently viewed automatically when a power switch is switched on. The channel automatically selected by the TV receiver, however, is not necessarily the channel which the user wishes to view. Furthermore, when the user wished to confirm the contents of the TV programs which are delivered in the channels frequently viewed, the user must be input the numbers of the channels to be viewed serially with using the numerical keypads. Thus, the operationality of the TV receiver for selecting the channels serially is not improved.

Furthermore, Japanese Laid-Open Patent Publication No. 4-77109, 8-140003, 8-181927 or 2000-333094 discloses another conventional TV receiver having a function for displaying a plurality of images of different channels on the same display screen, which is called picture in picture function so that a plurality of images of the channels are displayed with sizes corresponding to the viewing frequency. It, however, is premised on the TV receiver having the picture in picture function, so that an expensive microprocessor having high graphic processing capacity is needed. Furthermore, it is necessary to operate a plurality of keypads for moving a cursor on the images displayed on the display screen and deciding a channel to be viewed.

On the other hand, it is proposed to enter the channels frequently viewed as favorite channels and to call up one of the favorite channels by the user in the channel selection as a method for improving the operationality of the TV receiver. Such a method, however, requires the user to enter the favorite channels previously, so that initial operation of the TV receiver is not simplified. Still furthermore, the user may not understand the function of the TV receiver that the favorite channels can be entered previously.

### SUMMARY OF THE INVENTION

A purpose of the present invention is to provide a television broadcast signal receiver by which channels frequently viewed can be selected by a simple operation.

A television broadcast signal receiver in accordance with an aspect of the present invention comprises a tuner for selecting a channel among a plurality of receivable channels by tuning a reception frequency to a frequency of the channel selected by a user, a controller for controlling channel selection of the tuner, a memory for storing viewing recode of each receivable channel, and a simplified channel selection button which is operated for selecting channels in order of viewing frequency.

The controller extracts a plurality of channels having viewing frequency equal to or higher than a predetermined level based on the viewing recode of each channel stored in the memory and decides an order of viewing frequency of the extracted channels. When the simplified channel selection button is operated by the user, the controller controls the channel selection of the tuner based on the order of viewing frequency of the extracted channels so that a channel is selected among the extracted channels following to the order of viewing frequency at each time when the simplified channel selection button is operated by the user, and thereby the channels having the viewing frequency lower than the predetermined level are omitted from the channel selection caused by the operation of the simplified channel selection button.

With such a configuration, when the user repeatedly operates the simplified channel selection button, the channels having the viewing frequency equal to or higher than the predetermined level are serially selected in the order of the viewing frequency. Thus, the user can select a channel which he or she wishes to view among the channels having high viewing frequency with a simple operation of channel selection. The extraction of the channels having high viewing frequency is automatically performed.based on the viewing recode of the receivable channel, so that the user is not required to operate keypads for listing the favorite channels.

### BRIEF DESCRIPTION OF THE DRAWINGS

FIG. 1 is a block diagram showing a configuration of a television broadcast signal receiver (TV receiver) in accordance with an embodiment of the present invention;

FIG. 2 is a flowchart showing a process for counting up viewing points of each receivable channel in the above mentioned TV receiver;

FIG. 3 is an explanatory diagram showing the viewing points of each channel and a list of viewing frequency of each channel formed with using the viewing points of the channel;

FIG. 4 is a chart showing an example of the list of viewing frequency of each channel;

FIG. 5 is a flowchart showing a process for forming the list of viewing frequency of each channel in the above mentioned TV receiver;

FIG. 6 is an explanatory chart showing an example of the list of viewing frequency of each channel;

FIG. 7 is a flowchart showing a process of channel selection control in the above mentioned TV receiver; and

FIG. 8 is an explanatory diagram showing the channels which are selected when a keypad of the above mentioned TV receiver for selecting channels in order of viewing frequency is operated.

### DETAILED DESCRIPTION OF THE EMBODIMENT

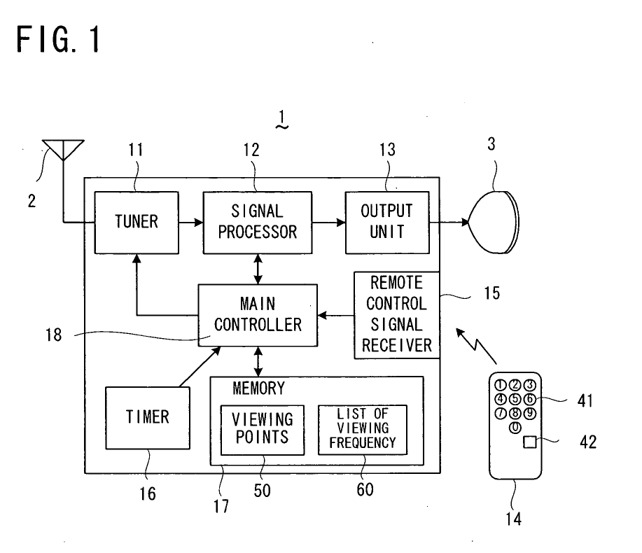

A television broadcast signal receiver (TV receiver) in accordance with an embodiment of the present invention is described with reference to the figures. The TV receiver 1 receives television broadcast signal (hereinafter, abbreviated as TV signal) delivered from a TV station through an antenna 2, and outputs audio signal and visual signal included in the TV signal to a monitor display apparatus. As can be seen from FIG. 1, the TV receiver 1 comprises a tuner 11 used for selecting a channel, a signal processor 12 for processing the TV signal, an output unit 13 for outputting the audio signal and the visual signal to the monitor display apparatus 3, a wireless remote control apparatus 14, a wireless remote control signal receiver 15, a timer 16, a memory 17 for memorizing various information, and a main controller 18 for controlling entire of the TV receiver 1.

The tuner 11, which serves as a channel selection means, performs channel selection of an appointed channel by tuning the receiving frequency thereof to a frequency corresponding to a channel selected by a user. The signal processor 12 processes the TV signal received with the tuner 11 so as to extract the audio signal and visual signal from the TV signal. The extracted audio signal and visual signal are outputted to the monitor display apparatus 3 through the output part 13, so that image is displayed on a monitor screen of the monitor display apparatus 3, and sound is outputted from speakers (not shown).

The remote control apparatus 14 comprises numerical keypad 41 which is operated for inputting a channel number and a simplified channel selection button 42 which is operated for selecting channels in order of viewing frequency. The wireless remote control apparatus 14 transmits infrared ray signal corresponding to the key operation by the user. The wireless remote control signal receiver 15 receives the infrared ray signal transmitted from the wireless remote control apparatus 14 and outputs a control signal corresponding to the received infrared ray signal to the main controller 18. The timer 16 serves as not only a clock but also a timer in a process for counting up viewing points of each channel which will be described later.

The memory 17, which serves as a means for storing viewing record of each receivable channel and an order of viewing frequency, stores viewing points of each channel 50 obtained in the addition process of viewing points, and memorizes a list of viewing frequency 60 formed in a process for forming the list of viewing frequency which will be described later.

The main controller 18 performs various processes following to programs stored in a ROM (not shown) so as to control the entire of the TV receiver 1. When the main controller 18 performs a process of channel selection control which will be described later, it serves as a channel selection control means with controlling the channel selection operation of the tuner 1. When the main controller 18 performs the process for counting up viewing points, it serves as viewing points calculation means so as to count up the number of the viewing points of each channel one by one at each time when a predetermined time period has passed while the same channel is continuously selected with the tuner 11, and to output the viewing record of the channel as a value of the viewing points. When the main controller 18 performs the process for forming the list of viewing frequency, it serves as a calculation means of order of viewing frequency so as to account the viewing points in a predetermined term with respect to each receivable channel based on the value of the viewing points stored in the memory 17 at a predetermined interval, to extract only the channels that a sum of the value of the viewing points thereof is higher than a predetermined value, and to output the order of viewing frequency of these channels.

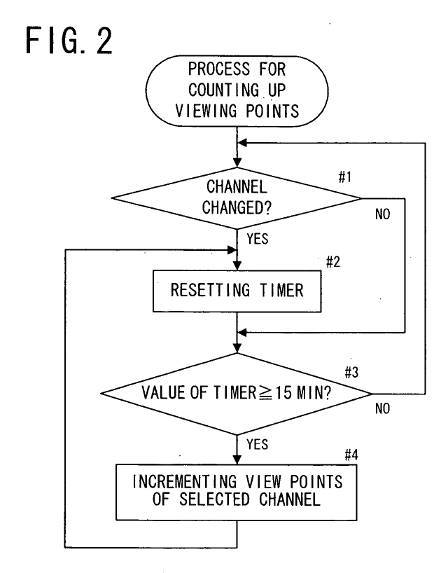

Subsequently, the process for counting up viewing points is described with reference to FIG. 2. The process for counting up viewing points is repeatedly performed while an optional channel is selected with the tuner 11. The main controller 18 observes whether the channel selected with the tuner 11 is changed or not corresponding to the operation of the numerical keypad 41 or the simplified channel selection button 42 by the user (#1). When the channel is changed (YES in step #1), the main controller 18 resets a counting value of the timer to “0” (#2). Then, the main controller 18 judges whether the counting value of the timer is equal to or larger (longer) than a predetermined time period, for example, fifteen minutes or not (#3). When the counting value of the timer is smaller (shorter) than the predetermined time period (NO in step #3), the main controller 18 returns to the step #1 so as to observe whether the channel is switched or not until the counting value of the timer becomes equal to or larger than the predetermined time period. When the counting value of the timer becomes equal to or larger than the predetermined time period (YES in step #3), the main controller 18 increments the value of viewing points of the channel which is selected with the tuner 11, and returns to the step #2 so as to reset the counting value of the timer (#4).

While the above mentioned processes are repeated, the main controller 18 does not count up the viewing points of channels which are not selected in succession equal to or longer than the predetermined time period. On the other hand, the main controller 18 counts up the viewing points of the channel, which is selected in succession equal to or longer than the predetermined time period, at each time when the predetermined time period has passed.

Besides, the predetermined time period, that is, the interval of counting up the viewing points is not limited to the above example of fifteen minutes. For example, the predetermined time period may be set to be shorter than a time period into which commercials are inserted. In such a case, it is possible to count up the viewing points of a channel that a TV program was viewed by the user before the commercials although the channel is changed during the commercials.

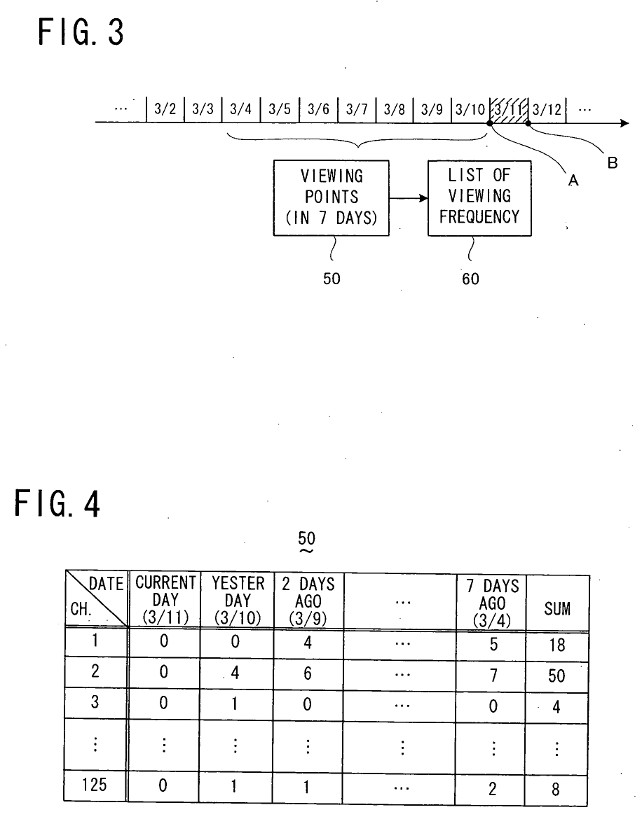

The viewing points of each channel counted by the above mentioned processes is managed in datal, and data of the viewing points of each channel in a predetermined term, for example, seven days is stored in the memory 17. Hereupon, an example of a list of viewing frequency of each channel is described with reference to FIGS. 3 and 4. FIG. 3 shows an example of a calendar and FIG. 4 shows an example of the list of viewing points of each channel. For example, at March 11, the memory 17 memorizes the viewing points 50 in the predetermined term, for example, seven days from March 4 (3/4) to March 10 (3/10) other than the viewing points at March 11. In this way, it is possible to reduce the capacity of the memory 17 necessary for managing the viewing recode of each receivable channel because only the viewing points 50 in the predetermined term are stored in the memory 17. Furthermore, when the viewing points 50 of seven days are stored in the memory 17, it is possible to manage the viewing recode corresponding to the TV programs which are delivered at a cycle of seven days.

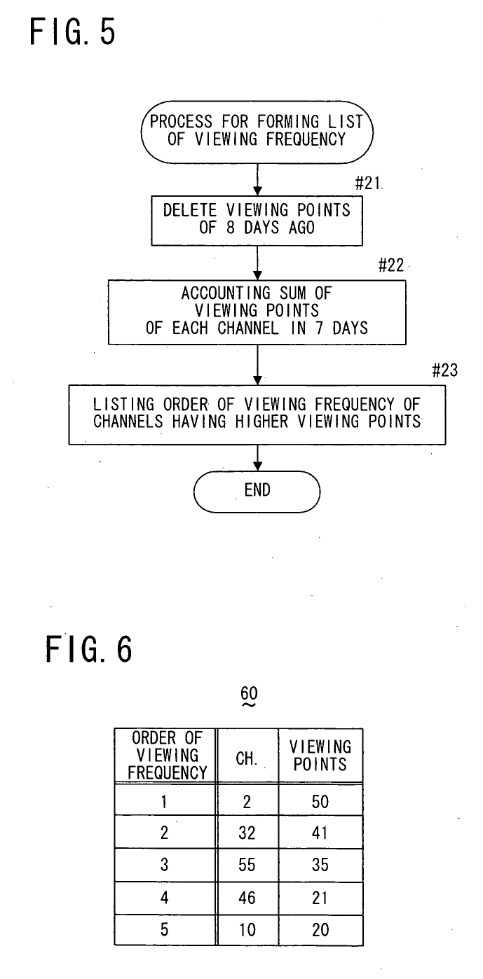

Subsequently, a process for forming a list of viewing frequency which is performed when a list of viewing frequency 60 is formed based on the viewing points 50 is described with reference to a flowchart shown in FIG. 5. The main controller 18 observes current time based on outputs from the timer 16, and starts the process for forming the list of viewing frequency 60, for example, when it is just at AM 0:00. When the process for forming the list of viewing frequency 60 is started, the main controller 18 deletes the viewing points of each channel of eight days ago (#21). In the example shown in FIG. 3, the viewing points 50 of March 3 are deleted just at AM 0:00 of March 11 (at a point A in FIG. 3). Subsequently, a sum of viewing points of each channel in the predetermined term, for example, from one day ago to seven days ago is calculated (#22). In the example shown in FIGS. 3 and 4, the sum of the viewing points of each channel from March 4 to March 10 is calculated. Then, channels having the sum of viewing points equal to or higher than a predetermined value or level are extracted, so that an order of viewing frequency of these channels is decided and the list of viewing frequency 60 is formed (#23). FIG. 6 shows an example of the list of viewing frequency 60. In the example shown in FIG. 6, the channels having the viewing points equal to or larger than 19 are extracted so as to form the list of viewing frequency 60, and priority numbers “1” to “5” are given to these channels in order of largeness of the viewing points. In addition, it is possible to limit a number of channels which are to be listed in the list of viewing frequency 60. In this embodiment, the process for forming the list of viewing frequency 60 is performed at predetermined time, for example, at AM 0:00 in a day. In the example shown in FIG. 3, the viewing points 50 of each channel is counted in a term from AM 0:00 of March 11 (point A) to AM 0:00 of March 12 (point B), but the list of viewing frequency 60 is not updated.

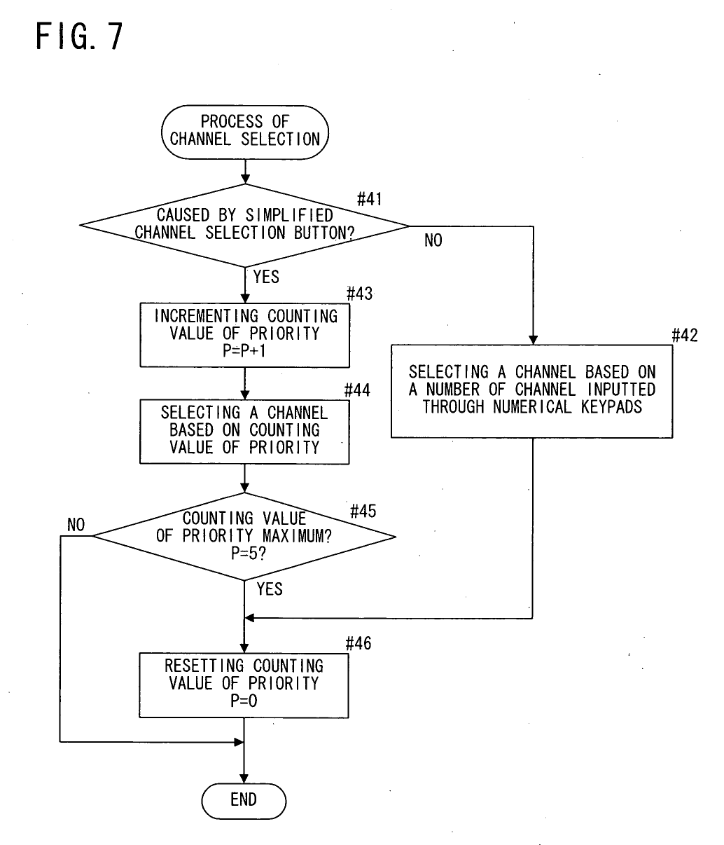

Subsequently, a process for selecting a channel is described with reference to a flowchart shown in FIG. 7. The main controller 18 observes whether the numerical keypad 41 or the simplified channel selection button 42 of the wireless remote control apparatus 14 is operated by the user or not. When the numerical keypad 41 or the simplified channel selection button 42 is operated, the main controller 18 starts the process for selecting a channel. At first, the main controller 18 judges which of the numerical keypad 41 and the simplified channel selection button 42 is caused the start of the process for selecting a channel (#41). When the start of the process for selecting a channel is caused by the numerical keypad 41 (NO in step #41), the main controller 18 makes the tuner 11 select a channel corresponding to a channel number inputted through the numerical keypad 41 (#42), and resets a counting value of priority to “0” (#46).

On the other hand, when the start of the process for selecting a channel is caused by the simplified channel selection button 42 (YES in step #41), a counting value of a priority is incremented (#43), and a channel is decided and selected based on the counting value of the priority (#44). Hereupon, when the prior selection of the channel is caused by the operation of the numerical keypad 41 (NO in step #41), the counting value of the priority is reset in the step #46, so that the counting value of priority in the step #44 becomes “1” due to the incrementation in the step #43. In the example shown in FIG. 6, the channel “2” having the number of priority “1” in the list of viewing frequency 60 is selected in the step #44. Then, the main controller 18 judges whether the counting value of priority reaches to a maximum value or not (#45). When the counting value of priority reaches to the maximum value (YES in step #45), the main controller 18 resets the counting value of priority (#46). Alternatively, when the counting value of priority has not reached to the maximum value (NO in step #45), the main controller 18 completes the process. The maximum value of the counting value of priority is decided by, for example, a number of channels listed in the list of viewing frequency 60. In the example shown in FIG. 6, the maximum value of the counting value of priority is set to be “5”.

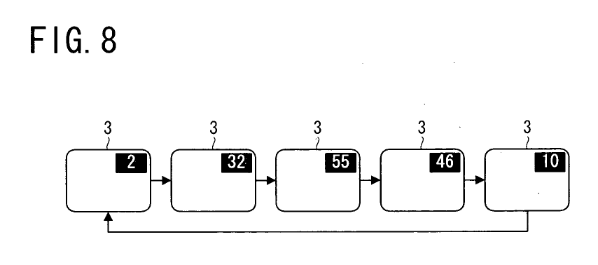

In the example shown in FIG. 6, it is assumed that the channel “2” having the priority number “1” on the order of viewing frequency is selected caused by the operation of the simplified channel selection button 42. At this time, the counting value of priority is “1”. When the simplified channel selection button 42 is further operated, the counting value of priority is incremented so as to be “2” in the step #42, and the channel “32” having the priority number “2” on the order of viewing frequency is selected. Similarly, it is assumed that the channel “10” having the priority number “5” on the order of viewing frequency is selected after operating the simplified channel selection button 42 several times. At this time, the counting value of priority becomes “0” because it is reset in the step #46. When the simplified channel selection button 42 is further operated, the counting value of priority is incremented to be “1” in the step #42, so that the channel “2” will be selected again. In this way, with operating the simplified channel selection button 42, the channels “2”, “32”, “55”, “46” and “10” are selected cyclically. In the example shown in FIG. 8, the TV receiver 1 has a picture-in-picture function so that the images of TV programs of these channels are cyclically displayed on the monitor screen 3 with a smaller size which is superimposed on an image of a channel which was selected just before the TV receiver 1 was switched off.

When the simplified channel selection button 42 is operated by the user, the main controller 18 performs the above mentioned process, so that it controls the channel selection on the basis of the order of viewing frequency of the channels listed on the list of viewing frequency 60 which is stored in the memory 17. More specifically, a channel is selected in order of largeness of the sum of the viewing points, in other words, on the order of the priority number of viewing frequency at each time when the simplified channel selection button 42 is operated. The channels having the sum of viewing points smaller than a predetermined value, that is, the channels which are not listed in the list of viewing frequency 60 are not selected in the channel selection process caused by the operation of the simplified channel selection button 42.

According to the above mentioned TV receiver 1 in this embodiment, the order of viewing frequency of each channel is decided on the basis of the viewing recode of each channel stored in the memory 17, the channels having viewing frequency equal to or higher than a predetermined level are serially selected in the order of largeness of viewing frequency at each time when the simplified channel selection button 42 is operated by the user, and the channels having the viewing frequency smaller than the predetermined value are not selected in the channel selection caused by the operation of the simplified channel selection button 42. Thus, the user can select only the channels having high viewing frequency with operating the simplified channel selection button 42 without any complex channel operation.

Furthermore, since the order of viewing frequency is decided on the viewing recode of each channel stored in the memory 17 and the channel selection is controlled on the basis of the order of viewing frequency when the simplified channel selection button 42 is operated. Thus, it is possible to select the channels each having high viewing frequency with simply operating the simplified channel selection button 42 without forcing any complex operation for listing the channels having high viewing frequency as favorite channels.

Still furthermore, the viewing point is counted one by one at each time when the same channel is continuously viewed equal to or longer than the predetermined time period and the counting result of the viewing points is stored as the viewing recode of the channel in the memory 17. Thus, the channel selection due to zapping, which should not be counted as the viewing recode essentially, may not be counted as the viewing recode, in comparison with the case that the viewing points of each channel is counted up whenever the channel is selected. Still furthermore, the viewing frequency is represented by the viewing points and the viewing points are counted up at each time when a predetermined time period has passed. Thus, it is possible to reduce a quantity of information which is to be stored in the memory 17 in comparison with the case that the time periods of viewing are directly stored as the viewing recode.

Still furthermore, the order of viewing frequency is decided with calculation of a sum of the viewing points of each channel in a predetermined term at a predetermined time interval, and stored in the memory 17. Thus, the main controller 18 has no need to perform the process for calculating the order of viewing frequency at each time when the simplified channel selection button 42 is operated by the user, so that the burden of the main controller 18 for processing the channel selection caused by the operation of the simplified channel selection button 42 can be reduced.

This application is based on Japanese patent application 2005-115402 filed Apr. 13, 2005 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A television broadcast signal receiver comprising:
a tuner for selecting a channel among a plurality of receivable channels by tuning a reception frequency to a frequency of the channel selected by a user;
a controller for controlling channel selection of the tuner;
a memory for storing viewing recode of each receivable channel; and
a simplified channel selection button which is operated for selecting channels in order of viewing frequency; wherein the controller extracts a plurality of channels having viewing frequency equal to or higher than a predetermined level based on the viewing recode of each channel stored in the memory and decides an order of viewing frequency of the extracted channels;
when the simplified channel selection button is operated by the user, the controller controls the channel selection of the tuner based on the order of viewing frequency of the extracted channels so that a channel is selected among the extracted channels based on the order of viewing frequency at each time when the simplified channel selection button is operated by the user, and thereby the channels having the viewing frequency lower than the predetermined level are omitted from the channel selection caused by the operation of the simplified channel selection button.

2. The television broadcast signal receiver in accordance with claim 1, wherein
when a channel is continuously selected equal to or longer than a predetermined time period, the controller counts up a value of viewing points of the channel one by one at each time when the predetermined time period has passed so that the viewing recode of each receivable channel is represented as the viewing points; and
the viewing points of each receivable channel are stored in the memory.

3. The television broadcast signal receiver in accordance with claim 2, wherein
the predetermined time period is shorter than a time period into which commercials are inserted, thereby enabling to count up the viewing points of a channel that a television program was viewed before the commercials although the channel is changed during the commercials.

4. The television broadcast signal receiver in accordance with claim 1, wherein
the television broadcast signal receiver has a picture-in-picture function so that images of television programs of the extracted channels are displayed on a monitor screen with a smaller size which is superimposed on an image of a channel which was selected just before the television broadcast signal receiver was switched off.

5. The television broadcast signal receiver in accordance with claim 1, wherein
the memory stores only the viewing recode of each receivable channel in a seven days, and the viewing recode of each receivable channel of eight days ago is deleted from the memory.

6. A television broadcast signal receiver comprising:
a channel selection means for selecting an appointed channel;
a channel selection control means for controlling operation of channel selection with the channel selection means;
a viewing points counting means for counting up viewing points of a channel at each time when a predetermined time period has passed while the channel is continuously selected equal to or longer than the predetermined time period, and outputting a result of counting up of the viewing points as viewing record of the channel;
a viewing point memory means for storing the viewing points of each channel which is receivable by the channel selection means;
an order of viewing frequency decision means which accounts a sum of the viewing points of each channel in a predetermined term based on the viewing points stored in the viewing points memory means at a predetermined time interval, extracting a plurality of channels that the sum of the viewing points is equal to or larger than a predetermined value and deciding an order of viewing frequency of the extracted channels;
an order of viewing frequency memory means for storing the order of viewing frequency of the extracted channels by the order of viewing frequency decision means; and
a channel selection operating means which is operated by a user for selecting channels on the order of viewing frequency; and wherein
when the channel selection operating means is operated by a user, the channel selection control means controls the channel selection of the channel selection means based on the order of viewing frequency stored in the order of viewing frequency memory means, so that a channel is selected among the extracted channels based on the order of viewing frequency at each time when the channel selection operating means is operated by the user, and thereby the channels having the viewing frequency lower than the predetermined value are omitted from the channel selection caused by the operation of the channel selection operating means.
